(19) United States
(12) Patent Application Publication
(10) Pub. No.: US 2012/0076610 A1
(43) Pub. Date: Mar. 29, 2012

(54) SYSTEM AND APPARATUS FOR HOLDING AN OBJECT

(75) Inventors: Mazen A. Ba-abbad, Riyadh (SA); Fahad Hassan Saeed Almalki, Riyadh City (SA)

(73) Assignee: King Abdul Aziz City for Science and Technology, Riyadh (SA)

(21) Appl. No.: 12/893,178

(22) Filed: Sep. 29, 2010

(51) Int. Cl. F16B 17/00

(52) U.S. Cl. 411/80.1

(57) ABSTRACT

An apparatus and system for holding one or more objects is disclosed. The apparatus includes one or more holding units and a supporting unit. A holding unit of the one or more holding units includes a plurality of holding members. Additionally, the holding unit is operable between a contracted configuration and an expanded configuration to hold an object of the one or more object. The holding unit in the contracted configuration is capable of drilling one or more holes in the object. Further, the holding unit is capable of spreading the plurality of holding members within a hole of the one or more holes to achieve the expanded configuration and hold the object. Additionally, the supporting unit of the apparatus includes one or more motors to operate the one or more holding units.

### FIELD OF THE INVENTION

The present invention relates generally to an apparatus for holding an object.

### BACKGROUND OF THE INVENTION

Moving large and fragmented objects is a tedious operation. Especially, when a location where the large and fragmented objects are placed is difficult to access, the process of moving these fragmented objects is even more challenging. For example, considering a fragmented roof of a collapsed building due to a natural calamity, the risk involved in moving the fragmented roof is very high as the building may further collapse causing more casualties.

In the existing scenario, the fragmented objects are further broken into multiple pieces. The objects may be broken manually. However, entering an area of the fragmented objects may be difficult most of the occasions. In case the area is accessible for humans, there is a lot of risk involved in further breaking the fragmented objects. Additionally, explosives may also be used to break the fragmented objects into multiple pieces. However, the use of explosives is always dangerous.

Therefore, there is need for an apparatus to hold an object firmly such that the object is pulled using the apparatus.

### BRIEF DESCRIPTION OF DRAWINGS

A more complete description of the invention is provided by reference to the following detailed description when considered in conjunction with the accompanying drawings in which reference symbols indicate the same or similar components, wherein

FIG. 1A and FIG. 1B illustrate an apparatus to hold an object in accordance with an embodiment of the invention.

FIG. 2 illustrates the apparatus holding an object in accordance with an exemplary embodiment of the invention.

FIG. 3A and FIG. 3B illustrate a holding unit of the apparatus in a contracted configuration and an expanded configuration respectively, in accordance with an exemplary embodiment of the invention.

FIG. 4A and FIG. 4B illustrate an apparatus having one or more gripping units in accordance with an exemplary embodiment of the invention.

FIG. 5A and FIG. 5B illustrate a gripping unit operatively connected to a supporting unit of the apparatus in accordance with another exemplary embodiment of the invention.

FIG. 6A and FIG. 6B illustrate an apparatus for holding an object in accordance with an exemplary embodiment of the invention.

FIG. 7 illustrates a system for holding one or more objects in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE DRAWINGS

Before describing in detail embodiments that are in accordance with the invention, it should be observed that the embodiments reside primarily in combinations of a system components related to holding an object. Accordingly, the apparatus components have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions.

Generally speaking pursuant to various embodiments, the invention provides an apparatus for holding an object. The apparatus includes one or more holding units. A holding unit of the one or more holding units includes a plurality of holding members. Additionally, the holding unit is operable between a contracted configuration and an expanded configuration to hold the object. The holding unit in the contracted configuration is capable of drilling one or more holes in the object. Further, the holding unit is capable of spreading the plurality of holding members within a hole of the one or more holes to achieve the expanded configuration and hold the object. Additionally, the apparatus includes a supporting unit coupled to the one or more holding units. The supporting unit includes one or more motors to operate the one or more holding units.

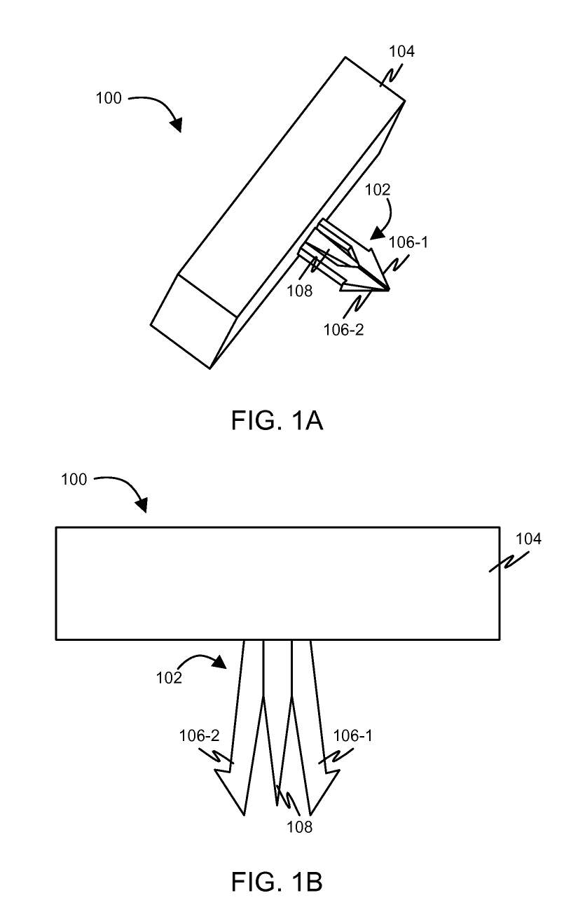

FIG. 1A and FIG. 1B illustrate an apparatus 100 to hold an object in accordance with an embodiment of the invention. The object may be one of, but is not limited to, a collapsed roof, a collapsed wall and a rock. However, it will be apparent to a person skilled in the art that the object may be any other object known in the art that needs to be moved from one location to another location. For example, apparatus 100 may be used for holding and removing collapsed roofs and walls from an earthquake affected location or any location affected by any natural calamities or other calamities. In another example, apparatus 100 may be used for holding and moving rocks from a location to another location.

Apparatus 100 includes one or more holding units and a supporting unit. A holding unit of the one or more holding units includes a plurality of holding members. In an embodiment, the holding unit may also include a supporting member for supporting the plurality of holding members. The one or more holding units may be coupled to the supporting unit. For example, apparatus 100 includes a holding unit 102 and a supporting unit 104. Holding unit 102 may be operatively coupled to supporting unit 104. Holding unit 102 includes a plurality of holding members such as, a holding member 106-1 and a holding member 106-2; and a supporting member 108 as illustrated in FIG. 1A and FIG. 1B. Apparatus 100 is shown to include one holding unit such as, holding unit 102 for ease of illustration and description, however apparatus 100 may include more than one holding units. Further, holding unit 102 is shown to include two holding members such as, holding member 106-1 and holding member 106-2 for ease of illustration and description, however holding unit 102 may include more than two holding members.

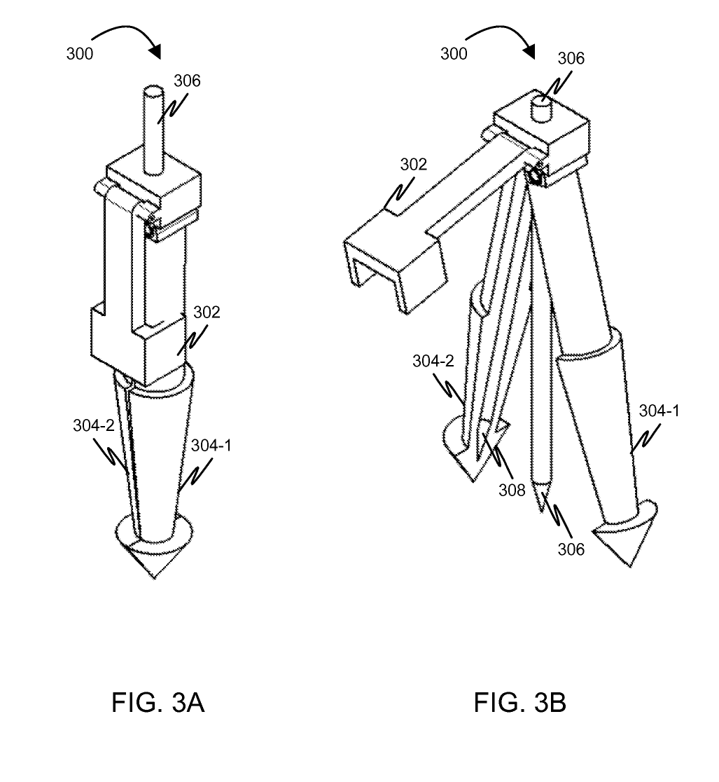

The holding unit of the one or more holding units is operable between a contracted configuration and an expanded configuration. For example, FIG. 1A illustrates holding unit 102 of apparatus 100 in a contracted configuration. In the contracted configuration, holding member 106-1 and holding member 106-2 of holding unit 102 are positioned close to each other. Holding member 106-1 and holding member 106-2 are closely positioned such that holding member 106-1 and holding member 106-2 are aligned closed to supporting member 108. More specifically, supporting member 108 is positioned between holding member 106-1 and holding member 106-2. Further, FIG. 1B illustrates holding unit 102 of apparatus 100 in an expanded configuration. In the expanded configuration, holding member 106-1 and holding member 106-2 are spread apart to achieve the expanded configuration. Holding member 106-1 and holding member 106-2 may spread apart with respect to supporting member 108. In an embodiment, holding member 106-1 and holding member 106-2 may be spread apart by operating supporting member 108. Holding unit such as, holding unit 102 is further explained in conjunction with FIG. 3A and FIG. 3B. In an embodiment, a motor (not shown in FIG. 1A and FIG. 1B) may operate holding unit 102 between the contracted configuration and the expanded configuration. In this case, the motor may be present within supporting unit 104 and operatively connected to holding unit 102.

Further, in an embodiment, the apparatus may include one or more clamping units (not shown in FIG. 1A and FIG. 1B). A clamping unit of the one or more clamping units is operatively coupled to the holding unit such as, holding unit 102. The clamping unit operates the holding unit between the contracted configuration and the expanded configuration. The clamping unit may be one of, but is not limited to, one or more clamps, a spring mechanism, a motor and a ratchet type mechanism. An exemplary embodiment for the clamping unit is further explained in detail in conjunction with FIG. 3A and FIG. 3B.

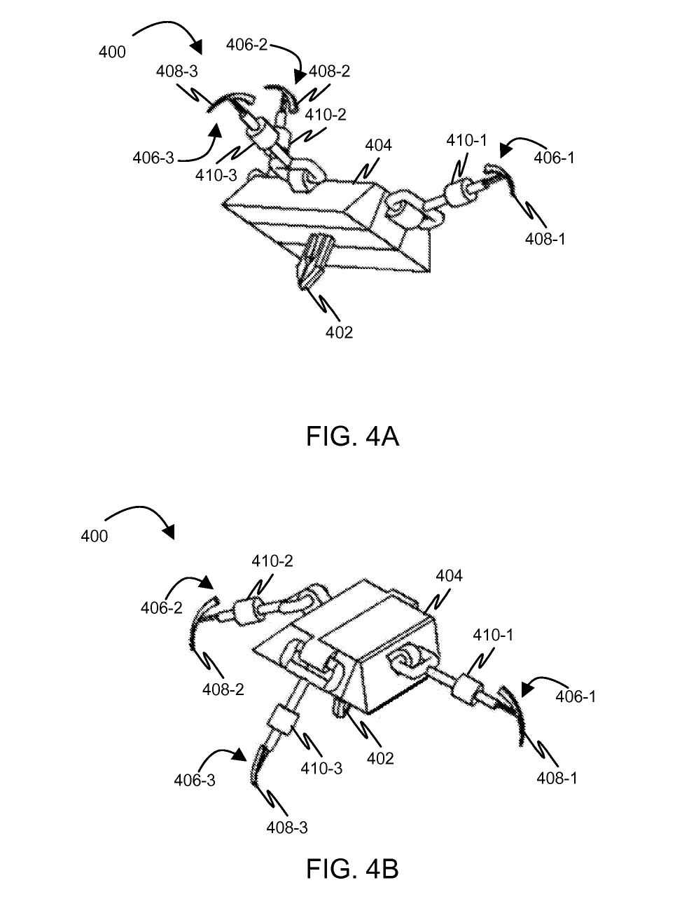

In the contracted configuration, the holding unit is capable of drilling one or more holes in the object. In this case, the holding unit may rotate to drill the one or more holes. In order to drill the one or more holes, in an embodiment, outer peripheral surface of the plurality of holding members may have a threaded arrangement (not shown in FIG. 1A and FIG. 1B). The threaded arrangement provided on the plurality of holding members facilitates in effectively drilling the one or more holes in the object. For example, holding unit 102 may have a threaded arrangement on an outer peripheral surface of holding member 106-1 and holding member 106-2. Thus, once holding unit 102 in the contracted configuration is brought in contact with the object, holding unit 102 rotates to drill a hole in the object. A force is applied by a mechanism such as, a gripping unit on holding unit 102 to drive holding unit 102 against the object for drilling the hole. The gripping unit used for gripping the object and to drive apparatus 100 against the object is explained in detail in conjunction with FIG. 4A and FIG. 4B. However, it will be apparent to a person skilled in the art that an apparatus such as, apparatus 100 may be equipped with any other mechanism known in the art to force the holding unit such as, holding unit 102 against the object for drilling the hole. Further, while drilling the one or more holes, supporting unit 104 may provide support to holding unit 102.

In an embodiment, holding unit 102 may be operated by a motor (not shown in FIG. 1A and FIG. 1B). Supporting unit 104 may include the motor for rotating holding unit 102 for drilling the one or more holes. In this case, the motor may be controlled by a control unit (not shown in FIG. 1A and FIG. 1B) present within apparatus 100.

In an embodiment, the one or more holes may be drilled in the object by the supporting member such as, supporting member 108 of apparatus 100. In this case, supporting member 108 may also have a threaded arrangement (not shown in FIG. 1A and FIG. 1B) on its peripheral surface to drill the one or more holes. For drilling the hole using supporting member 108, the plurality of holding members such as, holding member 106-1 and holding member 106-2 may be smaller in length as compared to the supporting member such as, supporting member 108. For example, holding unit 102 in the contracted configuration may be positioned on the object. In this case, supporting member 108 that is longer as compared to holding member 106-1 and holding member 106-2 may rotate to drill a hole in the object. A force is applied by a mechanism such as, a gripping unit on holding unit 102 to drive supporting member 108 against the object for drilling the hole. The gripping unit is explained in detail in conjunction with FIG. 4A and FIG. 4B. However, it will be apparent to a person skilled in the art that an apparatus such as, apparatus 100 may be equipped with any other mechanism known in the art to force the holding unit such as, holding unit 102 against the object for drilling the hole. In an embodiment, supporting member 108 may be operated by a motor. In this case, supporting unit 104 may include a motor for operating supporting member 108. Further, the motor may be operated by the control unit present in apparatus 100.

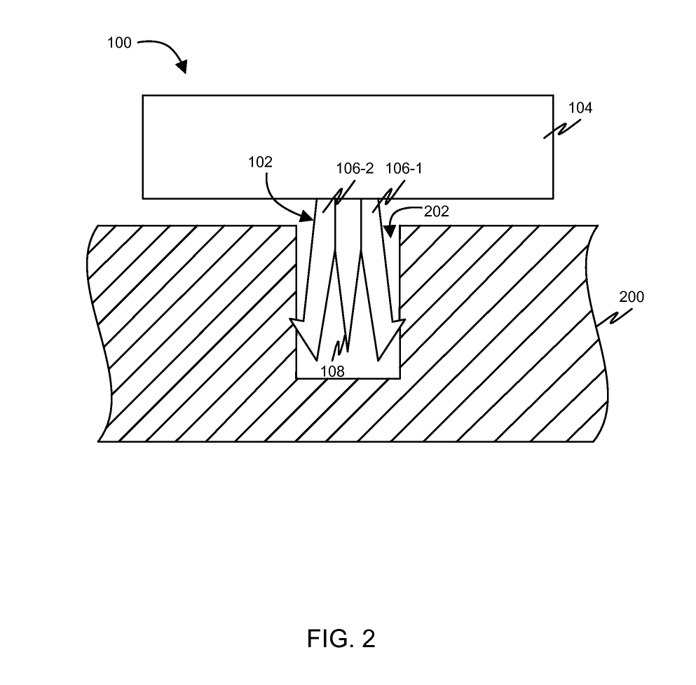

Once the one or more holes are drilled in the object, each holding unit of the one or more holding units is capable of spreading the plurality of holding members in a hole of the one or more holes to achieve the expanded configuration. In response to achieving the expanded configuration, the plurality of holding members may be fixed within the hole. Thus, the one or more holding units enable apparatus 100 to hold the object. For example, holding member 106-1 and holding member 106-2 may be capable of being positioned within a hole in an object. Then holding member 106-1 and holding member 106-2 may spread apart within the hole to achieve the expanded configuration. Once the expanded configuration is achieved, holding member 104-1 and holding member 104-2 are tightly positioned within the hole. This is explained further in detail in conjunction with FIG. 2.

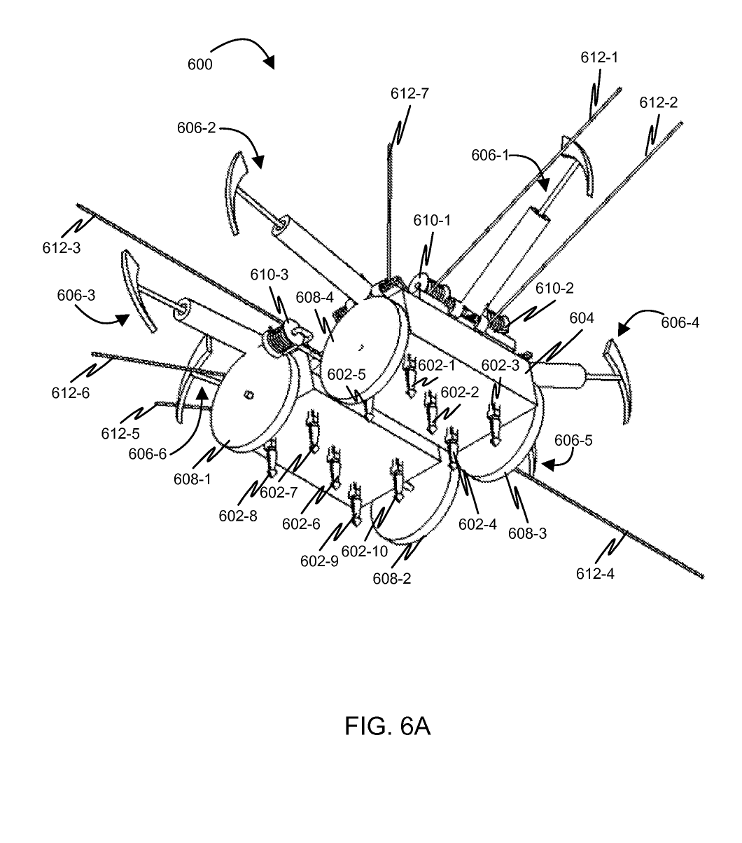

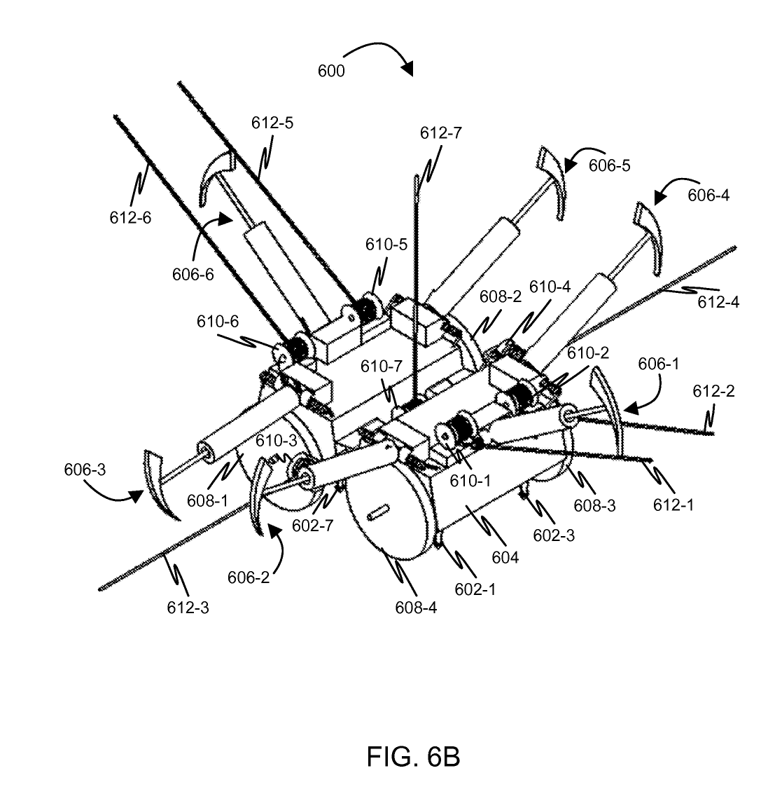

Further, in an embodiment, the apparatus such as, apparatus 100 may include one or more wheels operatively coupled to the supporting unit such as, supporting unit 104. The one or more wheels may be used to move the apparatus on the object. Additionally, the one or more wheels may be used to place the apparatus properly on the object. For example, while placing apparatus 100 on the object, one or more wheels provide support to apparatus 100 such that the one or more holding units of apparatus 100 point perpendicular to a surface of the object in order to drill a hole in the object. The one or more wheels of the apparatus are explained in conjunction with FIG. 6A and 6B.

Moreover, in another embodiment, the apparatus may include one or more pulley mechanisms operatively coupled to the supporting unit. A pulley mechanism of the one or more pulley mechanisms is capable of being operatively connected to a pulling unit. The pulling unit is used for pulling or holding the apparatus. For example, the pulley mechanism may be used to pull or lift the apparatus thereby pulling or lifting the object held by the apparatus using the holding unit. The pulling unit may be but not limited to, a magnetic pulling unit and a suction pulling unit. In the case of a magnetic pulling unit, the magnetic pulling unit may pull and hold an apparatus such as, apparatus 100 using a magnetic force. Further, in the case of a suction pulling unit, the suction pulling unit may pull and hold an apparatus such as, apparatus 100 using a suction force. In an embodiment, the suction force may be generated using vacuum pressure.

Additionally, the pulley mechanism along with the pulling unit may be used to position the apparatus on the object. For example, consider the apparatus including one or more wheels. This apparatus may be positioned on the object using a pulley mechanism operatively connected to the pulling unit. This is further explained in detail in conjunction with FIG. 6A and FIG. 6B.

FIG. 2 illustrates apparatus 100 holding an object 200 in accordance with an exemplary embodiment of the invention. Apparatus 100 includes holding unit 102 and supporting unit 104. Holding unit 102 includes holding member 106-1, holding member 106-2, and supporting member 108. Holding member 106-1 and holding member 106-2 are spread apart with respect to supporting member 108 to achieve an expanded configuration within a hole 202 in object 200.

In an embodiment, hole 202 may be drilled by a holding unit such as, holding unit 102. For example, holding unit 102 in a contracted configuration drills hole 202 in object 200. In response to drilling hole 202, holding member 106-1 and holding member 106-2 spread apart within hole 202 to achieve an expanded configuration. In the expanded configuration, holding member 106-1 and holding member 106-2 may be securely positioned within hole 202. Thus, holding member 106-1 and holding member 106-2 may firmly grip to an inner surface of hole 202 thereby enabling apparatus 100 to hold object 200.

In an embodiment, apparatus 100 may include one or more sensors (not shown in FIG. 2) capable of detecting a creation of hole 202. The one or more sensors may use any technologies known in the art for detecting the creation of hole 202. Once hole 202 is created, one or more sensors may send instructions to the motor for operating holding unit 102 to attain the expanded configuration within hole 202. Alternatively, the one or more sensors may send instructions to the control unit present in apparatus 100 for enabling holding unit 102 to attain the contracted and expanded configuration. In this case, the control unit may then operate the motor to drive holding unit 102 to attain the contracted and expanded configuration. In an embodiment, the one or more sensors may be located within holding member 106-1 and holding member 106-2. Thus, when holding unit 102 drills hole 202, the one or more sensors may easily detect the creation of hole 202.

In an embodiment, hole 202 may already present in object 200. For example, apparatus 100 may be placed above hole 202 such that holding unit 102 in a contracted configuration may be positioned within hole 202. Thereafter, holding member 106-1 and holding member 106-2 spread apart within hole 202. Thus, holding member 106-1 and holding member 106-1 may firmly grip to the inner surface of hole 202 thereby enabling apparatus 100 to hold object 200.

Now moving to FIG. 3A and FIG. 3B, a holding unit 300 in a contracted configuration and an expanded configuration respectively are illustrated in accordance with an exemplary embodiment of the invention. Holding unit 300 includes a clamping unit 302, a holding member 304-1, a holding member 304-2, and a supporting member 306. Clamping unit 302 is operatively connected to holding unit 300 to clamp holding member 304-1 and holding member 304-2. Clamping unit 302 enables holding unit 300 to operate between the contracted configuration and the expanded configuration. A structure and configuration of clamping unit 302 as shown in FIG. 3A and FIG. 3B is according to an exemplary embodiment, and hence it may be noted that holding unit 300 may include a clamping unit that may have any other configuration and structure known in the art.

In the contracted configuration, holding member 304-1 and holding member 304-2 are positioned close to each other using clamping unit 302. More specifically, clamping unit 302 may clamp holding member 304-1 and holding member 304-2 closer to each other tightly as illustrated in FIG. 3A. Whereas, when holding unit 300 is in the expanded configuration, holding member 304-1 and holding member 304-2 may be spread apart as illustrated in FIG. 3B. Holding member 304-1 and holding member 304-2 may spread apart when clamping unit 302 is released.

In an embodiment, clamping unit 302 may be operated using a motor (not shown in FIG. 3A and FIG. 3B). The motor may operate clamping unit 302 based on the instructions received from the control unit present in the apparatus such as, apparatus 100. More specifically, the control unit may send instructions to the motor for releasing clamping unit 302 so that holding unit 300 attains the expanded configuration. Further, the control unit may send instructions to the motor for operating clamping unit 302 to tightly clamp holding member 304-1 and holding member 304-2 to each other thereby enabling holding unit 300 to attain the contracted configuration.

Alternatively, clamping unit 302 may be operated using supporting member 306. In this case, supporting member 306 may be similar to a screw arrangement that may be rotated in a clockwise and an anticlockwise direction for enabling holding unit 300 to attain the expanded configuration and contracted configuration.

When holding unit 300 is in the contracted configuration, supporting member 306 may be positioned between holding member 304-1 and holding member 304-2. In an embodiment, holding member 304-1 and holding member 304-2 may have a groove substantially extending throughout its length to accommodate supporting member 306 when holding unit 300 is in the contracted configuration. For example, holding member 304-1 may have a groove 308 substantially extending throughout its length. A portion of supporting member 306 may be positioned within groove 308. Similarly, holding member 304-2 may have a groove (not shown in FIG. 3B) to accommodate the remaining portion of supporting member 306 when holding unit 300 is in the contracted configuration.

Now referring back to the embodiment where supporting member 306 is used for operating clamping unit 302, supporting member 306 may move in the downward direction in response to rotating supporting member 306 in the clockwise direction. While moving in the downward direction, supporting member 306 is forced to move out through groove 308 thereby releasing clamping unit 302. Once clamping unit 302 is released, holding member 304-1 and holding member 304-2 may spread apart as illustrated in FIG. 3B. Alternatively, supporting member 306 may be pushed in the downward direction to force supporting member 306 to move out through groove 306. When supporting member 306 moves, holding member 304-1 and holding member 304-2 may be forced to spread apart. Thus, holding unit 300 attains the expanded configuration. Further, supporting member 306 may be pulled in an upward direction for enabling holding member 304-1 and holding member 304-2 to come closer to each other. In response to pulling supporting member 306, clamping unit 302 may automatically position itself to clamp holding member 304-1 and holding member 304-2 close to each other.

In an embodiment, supporting member 306 may be operated using a motor (not shown in FIG. 3A and FIG. 3B). In this scenario, the motor may rotate supporting member 306 in the clockwise and the anticlockwise direction for operating holding unit 300 between the expanded configuration and the contracted configuration. Alternatively, the motor may push and pull supporting member 306 to enable holding unit 300 to operate between the expanded and the contracted configuration. The motor may be housed within holding unit 300. Alternatively, the motor may be present within supporting unit 306.

FIG. 4A and FIG. 4B illustrate an apparatus 400 including one or more gripping units in accordance with an exemplary embodiment of the invention. More specifically, FIG. 4A illustrates a bottom perspective view of apparatus 400 and FIG. 4B illustrates a top perspective view of apparatus 400. Apparatus 400 is capable of holding an object. As illustrated, apparatus 400 includes a holding unit 402, a supporting unit 404, and the one or more gripping units such as, a gripping unit 406-1, a gripping unit 406-2, and a gripping unit 406-3. Gripping unit 406-1, gripping unit 406-2, and gripping unit 406-3 are capable of gripping the object thereby providing support for drilling one or more holes in the object.

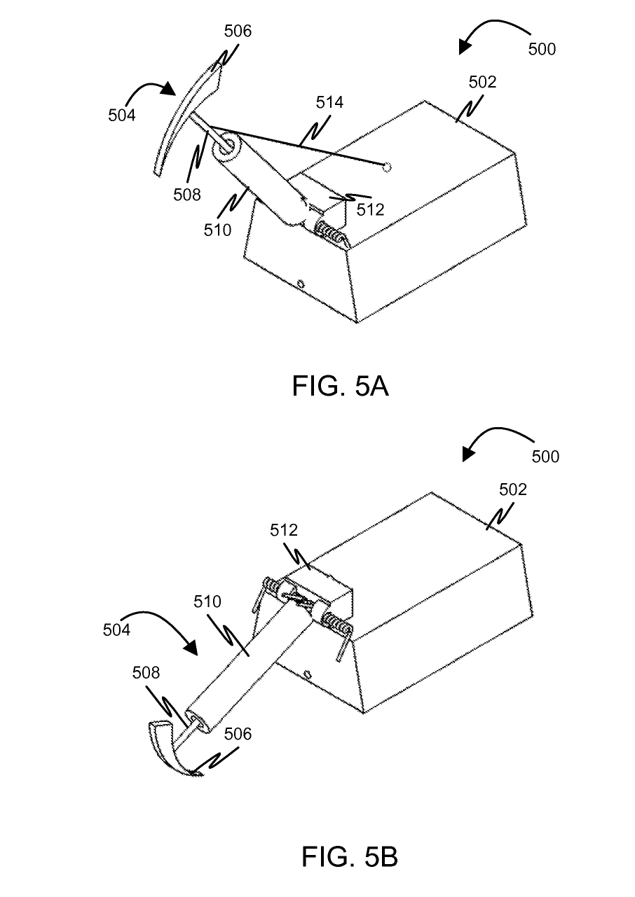

Gripping unit 406-1, gripping unit 406-2, and gripping unit 406-3 are operatively coupled to supporting unit 404. In an embodiment, a spring mechanism may be used to couple gripping unit 406-1, gripping unit 406-2, and gripping unit 406-3 to supporting unit 404. An exemplary embodiment for a spring mechanism is further explained in detail in conjunction with FIG. 5A and FIG. 5B. It will be apparent to a person skilled in the art that any other mechanism known in the art may also be used to operatively couple gripping unit 406-1, gripping unit 406-2, and gripping unit 406-3 to supporting unit 404.

Each gripping unit of the one or more gripping units includes an axe and a connecting member. For example, gripping unit 406-1 includes an axe 408-1 and a connecting member 410-1. Gripping unit 406-2 includes an axe 408-2 and a connecting member 408-2. Further, gripping unit 406-3 includes an axe 408-3 and a connecting member 410-3. The connecting member may have the axe at a first end of the connecting member. Whereas, a second end of the connecting member may be operatively coupled to a supporting unit of the apparatus. For example, connecting member 410-1 may have axe 408-1 at a first end of connecting member 410-1. Further, a second end of connecting member 410-1 may be operatively connected to supporting unit 404. In this case, gripping unit 406-1 may angularly move with respect to supporting unit 404.

In an embodiment, the connecting member may be a hydraulic actuator. The hydraulic actuator may be capable of operating the axe between a retracted configuration and an extended configuration. This is further explained in detail in conjunction with FIG. 5A and FIG. 5B.

To provide support for drilling a hole of the one or more holes in the object, the one or more gripping units such as, gripping unit 406-1, gripping unit 406-2, and gripping unit 406-3 are released or angularly moved towards the object. In response to releasing the one or more gripping units, one or more axes such as, axe 408-1, axe 408-2, and axe 408-3 grip the object. Thereafter, apparatus 400 drills the hole in the object using holding unit 402. While drilling the hole, the one or more gripping units prevent the apparatus from moving away from the object. For example, the one or more axes such as, axe 408-1, axe 408-2, and axe 408-3 may grip firmly to the object thereby preventing the apparatus such as, apparatus 400 from moving in a direction opposite to a direction of drilling the hole. More specifically, as the one or more axes such as, axe 408-1, axe 408-2, and axe 408-3 firmly grip the object, the one or more axes may accommodate a force applied while drilling the hole in the object.

In an embodiment, the one or more gripping units such as, gripping unit 406-1, gripping unit 406-2, and gripping unit 406-3 are released towards the object in response to placing the apparatus such as, apparatus 400 on the object. In this case, an apparatus such as, apparatus 400 may include one or more sensors (not shown in FIG. 4A and FIG. 4B) to detect placement of the apparatus on the object. The placement of the apparatus on the object may be detected by determining stability of apparatus 400 for drilling the one or more holes in the object. In response to detecting the placement of the apparatus, the one or more sensors may instruct the one or more gripping units to move towards the object for gripping the object. In another embodiment, the apparatus such as, apparatus 400 may include the control unit to operate the one or more gripping units to be released towards the object. In this case, the control unit may receive information associated with the placement of the apparatus on the object from the one or more sensors. Thereafter, the one or more gripping units may be released to grip the object.

Further, the one or more gripping members may also provide additional support for holding the object using the holding unit such as, holding unit 402. For example, upon drilling a hole in the object, holding unit 402 achieves an expanded configuration to hold the object. In this case, gripping unit 406-1, gripping unit 406-2, and gripping unit 406-3 have already gripped the object before drilling the hole. Thus, gripping unit 406-1, gripping unit 406-2, and gripping unit 406-3 provide additional support in holding the object using holding unit 402.

FIG. 5A and FIG. 5B illustrates an apparatus 500 including a gripping unit 504 operatively connected to a supporting unit 502 in accordance with another exemplary embodiment of the invention. Gripping unit 504 includes an axe 506, an arm 508, and a hydraulic actuator 510. Hydraulic actuator 510 may be used to operate arm 508 between a retracted configuration and an extended configuration. For example, arm 508 may have axe 506 configured at a first end. A second end of arm 508 may be operatively connected to hydraulic actuator 510. Arm 508 may move in and out of hydraulic actuator 510 to operate between the retracted and the extended configuration, respectively. Further, gripping unit 504 is operatively connected to supporting unit 502 using a spring mechanism 512 and a string 514. Spring mechanism 512 is used to operate gripping unit 504 for gripping the object. Further, apparatus 500 as illustrated in FIG. 5A and 5B is shown not to include a holding unit for ease of representation, however apparatus 500 may include the holding unit such as, holding 102, holding unit 300 and holding unit 402.

FIG. 5A illustrates arm 508 of gripping unit 504 in an engaged configuration. In the engaged configuration, arm 508 is connected to supporting unit 502 using string 514. Further, arm 508 may be in the retracted configuration. In order to grip the object, arm 508 is extended using hydraulic actuator 510. In response to extending arm 508, tension in string 514 starts increasing. As a result, string 514 breaks and gripping unit 504 achieves a disengaged configuration as illustrated in FIG. 5B. This results in sudden release of gripping unit 504 towards the object. The sudden release of gripping unit 504 facilitates axe 506 to grip the object. Alternatively, when arm 508 extends, string 514 may extend so as to enable gripping unit 504 to achieve the disengaged configuration.

In an embodiment, gripping unit 504 is released in response to placing an apparatus such as, apparatus 500 on the object. In this case, the apparatus may include one or more sensors (not shown in FIG. 5A and FIG. 5B) to detect placement of the apparatus on the object. The placement of the apparatus may be detected by determining stability of the apparatus for drilling one or more holes in the object. For example, in response to detecting the placement of apparatus 500 on an object, the one or more sensors may instruct hydraulic actuator 510 to extend arm 508. As a result, string 514 breaks and arm 508 achieves the extended configuration thereby releasing gripping unit 504 towards the object. In another embodiment, the apparatus may include the control unit to instruct hydraulic actuator 510 to extend arm 508. As a result, gripping unit 504 may be released towards the object for gripping the object. In this case, the control unit may receive information associated with the placement of apparatus 500 on the object from the one or more sensors.

Turning now to FIG. 6A and FIG. 6B, an apparatus 600 for holding an object is illustrated in accordance with an exemplary embodiment of the invention. More specifically, FIG. 6A illustrates a bottom perspective view of apparatus 600 and FIG. 6B illustrates a top perspective view of apparatus 600. Apparatus 600 includes one or more holding units such as, a holding unit 602-1, a holding unit 602-2, a holding unit 602-3, a holding unit 602-4, a holding unit 602-5, a holding unit 602-6, a holding unit 602-7, a holding unit 602-8, a holding unit 602-9, and a holding unit 602-10. Each of the one or more holding units includes a plurality of holding members. Further, each of the one or more holding units is operable between a contracted configuration and an expanded configuration. This has already been explained in detail in conjunction with FIG. 1A, FIG. 1B, FIG. 3A, and FIG. 3B.

In the contracted configuration, each of the one or more holding units is capable of drilling one or more holes in the object. Further, to achieve the expanded configuration, each of the one or more holding units is capable of spreading the plurality of holding members within a hole of the one or more holes thereby holding the object. This has already been explained in detail in conjunction with FIG. 1A, FIG. 1B, and FIG. 2.

Additionally, apparatus 600 includes a supporting unit 604 coupled to the one or holding units. Supporting unit 604 includes one or more motors (not shown in FIG. 6A and FIG. 6B) to operate the one or more holding units. For example, supporting unit 604 includes separate motors for each of holding unit 602-1, holding unit 602-2, holding unit 602-3, holding unit 602-4, holding unit 602-5, holding unit 602-6, holding unit 602-7, holding unit 602-8, holding unit 602-9, and holding unit 602-10. However, it will be apparent to a person skilled in the art that one motor may be used to operate more than one holding unit of the one or more holding units.

Further, apparatus 600 also includes one or more gripping units such as, a gripping unit 606-1, a gripping unit 606-2, a gripping unit 606-3, a gripping unit 606-4, a gripping unit 606-5, and a gripping unit 606-6 operatively coupled to supporting unit 604. Each of the one or more gripping units is capable of gripping the object thereby providing support for drilling the one or more holes in the object. For example, before drilling a hole in the object, the one or more gripping members are released towards the object thereby providing support to apparatus 600 for drilling the hole. This has already been explained in detail in conjunction with FIG. 4A, FIG. 4B, FIG. 5A, and FIG. 5B.

Apparatus 600 also includes one or more wheels such as, a wheel 608-1, a wheel 608-2, a wheel 608-3, and a wheel 608-4 operatively coupled to supporting unit 604. The one or more wheels may be operated by one or more motors. The one or more wheels may be used to position apparatus 600 on the object. The one or more wheels may also be used to roll apparatus 600 on the object to reach a predefined region on the object. For example, apparatus 600 may be positioned using the one or more wheels on a region of a collapsed roof which is sufficiently hard so that the one or more holding units are capable of drilling the one or more holes in the region of the collapsed roof.

Further, apparatus 600 includes one or more pulley mechanisms operatively coupled to supporting unit 604. The one or more pulley mechanisms includes one or more retractable units such as, a retractable unit 610-1, a retractable unit 610-2, a retractable unit 610-3, a retractable unit 610-4, a retractable unit 610-5, a retractable unit 610-6, and a retractable unit 610-7 and one or more cables such as, a cable 612-1, a cable 612-2, a cable 612-3, a cable 612-4, a cable 612-5, a cable 612-6, and a cable 612-7. Each of the one or more retractable units is operatively connected to a pulling unit using a cable of the one or more cables for pulling or lifting apparatus 600. For example, the pulling unit uses cable 612-7 and retractable unit 610-7 to pull apparatus 600 upwards thereby pulling the object held by apparatus 600.

In an embodiment, each retractable unit of the one or more retractable units may be operated using a motor. The motor may rotate a retractable unit of the one or more retractable units to wind or unwind a cable of the one or more cables. For example, if cable 612-7 is connected to retractable unit 610-7 at one end and fixed on the pulling unit at another end, length of cable 612-7 may be decreased upon rotating retractable unit 610-7 in a clockwise direction using a motor. While rotating in the clockwise direction, retractable unit 610-7 winds cable 612-7 thereby decreasing the length of cable 612-7. As a result, apparatus 600 is pulled in an upward direction. Alternatively, the length of cable 612-7 may be increased upon rotating retractable unit 610-7 in an anticlockwise direction using a motor. The length of cable 612-7 increases as retractable unit 610-7 unwinds cable 612-7 while rotating in the anticlockwise direction. As a result, apparatus 600 moves in a downward direction.

In another embodiment, one motor may be used to operate more than one retractable unit of the one or more retractable units. This may facilitate in operating multiple retractable units of the one or more retractable units to operate in synchronization. The synchronized operation of the one or more retractable units may prevent the apparatus such as, apparatus 600 from slacking For example, consider retractable unit 610-1, retractable unit 610-2, retractable unit 610-5, and retractable unit 610-6 are operated using a single motor. In this case, apparatus 600 may remain in same plane as of retractable unit 610-1, retractable unit 610-2, retractable unit 610-5, and retractable unit 610-6 in response to winding or unwinding cable 612-1, cable 612-2, cable 612-5, and cable 612-6.

The one or more retractable units may be operatively connected to the pulling unit to position the apparatus such as, apparatus 600 on the object. For example, retractable unit 610-3 and retractable unit 610-4 may be rotated to wind and unwind cable 612-3 and cable 612-4, respectively. The winding and unwinding of cable 612-3 and cable 612-4 may result in movement of apparatus 600 along cable 612-3 and cable 612-4. In this manner, apparatus 600 may be moved in any direction to position apparatus 600 on any region on the object.

Further, for holding an object, apparatus 600 is placed on the object. To place apparatus 600, retractable unit 610-1, retractable unit 610-2, retractable unit 610-3, retractable unit 610-4, retractable unit 610-4, retractable unit 610-5, retractable unit 610-6, and retractable unit 610-7 are operated such that apparatus 600 is positioned on a region of the object. These retractable units are operated to wind or unwind cable 612-1, cable 612-2, cable 612-3, cable 612-4, cable 612-5, cable 612-6, and cable 612-7. The winding and unwinding of these cables move apparatus 600 in one or more directions such as, but not limited to, left, right, front, and back direction to be positioned on the region on the object. Thereafter, holding unit 602-1, holding unit 602-2, holding unit 602-3, holding unit 602-4, holding unit 602-5, holding unit 602-6, holding unit 602-7, holding unit 602-8, holding unit 602-9, and holding unit 602-10 are capable of drilling one or more holes in the region on the object.

In response to placing apparatus 600 on the object, gripping member 606-1, gripping member 606-2, gripping member 606-3, gripping member 606-4, gripping member 606-5, and gripping member 606-6 are suddenly released on the object. As a result, these gripping members grip the object. Thereafter, holding unit 602-1, holding unit 602-2, holding unit 602-3, holding unit 602-4, holding unit 602-5, holding unit 602-6, holding unit 602-7, holding unit 602-8, holding unit 602-9, and holding unit 602-10 are instructed to drill the one or more holes in the object. A plurality of holding members of each holding unit drills a hole of the one or more holes in the object. The hole is drilled when the plurality of holding members are in a contracted configuration. In response to drilling the one or more holes, each holding unit of apparatus 600 may spread apart the plurality of holding members within their respective hole to achieve an expanded configuration thereby holding the object.

Further, apparatus 600 is pulled using a pulling unit coupled to retractable unit 610-1, retractable unit 610-2, retractable unit 610-3, retractable unit 610-4, retractable unit 610-4, retractable unit 610-5, retractable unit 610-6, and retractable unit 610-7 using cable 612-1, cable 612-2, cable 612-3, cable 612-4, cable 612-5, cable 612-6, and cable 612-7, respectively. Once apparatus 600 is pulled or lifted the object held by apparatus 600 is pulled or lifted.

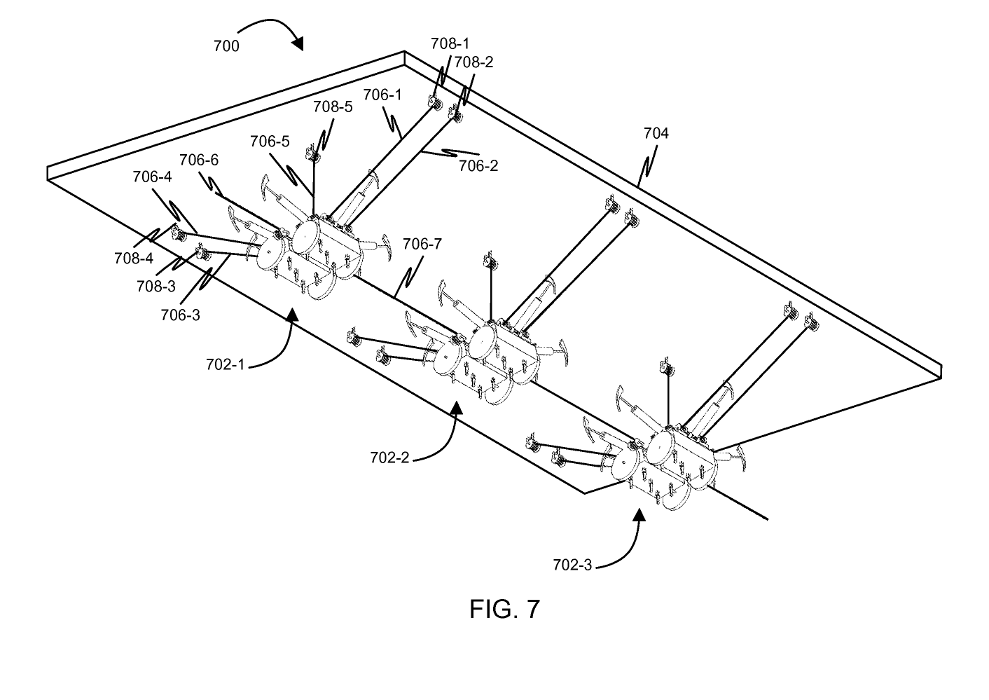

FIG. 7 illustrates a system 700 for holding one or more objects in accordance with an embodiment of the invention. System 700 includes a plurality of apparatuses such as, an apparatus 702-1, an apparatus 702-2, an apparatus 702-3, and an apparatus 702-4 for holding the one or more objects. An apparatus of the plurality of apparatuses has already been explained in accordance with an exemplary embodiment in conjunction with FIG. 6A and FIG. 6B.

Each apparatus of the plurality of apparatuses includes one or more holding units. The one or more holding units are configured to hold the one or more objects. A holding unit of the one or more holding units includes a plurality of holding members. Additionally, the holding unit is operable between a contracted configuration and an expanded configuration to hold an object of the one or more objects. In the contracted configuration, the holding unit is capable of drilling one or more holes in the object. Further, to achieve the expanded configuration, the holding unit is capable of spreading the plurality of holding members within a hole of the one or more holes thereby holding the object. This has already been explained in detail in conjunction with FIG. 1A, FIG. 1B, and FIG. 2.

In an embodiment, each apparatus of the plurality of apparatuses includes a clamping unit operatively coupled to each holding unit of the one or more holding units. The clamping unit operates a corresponding holding unit between the contracted configuration and the expanded configuration by clamping the plurality of holding members of the holding unit. This has already been explained in detail in conjunction with FIG. 3A and FIG. 3B.

Each apparatus of the plurality of apparatuses also includes a supporting unit coupled to the one or more holding units. The supporting unit includes one or more motors. The one or more motors are used to operate the one or more holding units. For example, a motor is used to operate a holding unit while drilling a hole in an object and spreading a plurality of holding members of the holding unit within the hole to hold the object. In an embodiment, each apparatus of the plurality of apparatuses includes one or more wheels operatively coupled to the supporting unit for positioning the apparatus on an object. This has already been explained in detail in conjunction with FIG. 6A and FIG. 6B.

In another embodiment, each apparatus of the plurality of apparatuses includes one or more gripping units operatively coupled to the supporting unit. A gripping unit of the one or more gripping units is capable of gripping the object thereby providing support for drilling the one or more holes in the object. The gripping unit may include one or more axes for gripping the object. This has already been explained in detail in conjunction with FIG. 4A, FIG. 4B, FIG. 5A and FIG. 5B.

Further, system 700 includes one or more pulling units. A pulling unit 704 of the one or more pulling units is capable of pulling one or more apparatuses of the plurality of apparatuses. Pulling unit 704 may be one of, but is not limited to, a magnetic pulling unit and a suction pulling unit.

In an embodiment, each apparatus of the plurality of apparatuses includes one or more pulley mechanisms operatively coupled to the supporting unit. Additionally, the one or more pulley mechanisms are operatively coupled to the one or more pulling units for pulling or lifting a corresponding apparatus of the plurality of apparatuses. A pulley mechanism of the one or more pulley mechanisms may include one or more retractable units. Each retractable unit of the one or more retractable units is operatively connected with the one or more pulling units using one or more cables. The one or more retractable units may also be used for positioning an apparatus of the plurality of apparatuses on the object. This has already been explained in detail in conjunction with FIG. 6A and FIG. 6B.

For example, apparatus 702-1 is connected to pulling unit 704 using a cable 706-1, a cable 706-2, a cable 706-3, a cable 706-4, and a cable 706-5. Cable 706-1, cable 706-2, cable 706-3, cable 706-4, and cable 706-5 may be connected to apparatus 702-1 using one or more retractable units present in apparatus 702-1. The one or more retractable units of apparatus 702-1 are not numbered in FIG. 7 for ease of illustration. Additionally, cable 706-1, cable 706-2, cable 706-3, cable 706-4, and cable 706-5 may be connected to pulling unit 704 using one or more retractable units such as, a retractable unit 708-1, a retractable unit 708-2, a retractable unit 708-3, a retractable unit 708-4, and a retractable unit 708-5 on pulling unit 704. As illustrated in FIG. 7, apparatus 702-2 and apparatus 702-3 are also connected to pulling unit 704 using one or more cables and one or more retractable units on pulling unit 704 similar to apparatus 702-1. However, the one or more cables and the one or more retractable units are not numbered for ease of illustration and clarity.

For holding an object, apparatus 702-1, apparatus 702-2 and apparatus 702-3 of system 700 are placed on the object. In order to place an apparatus of these apparatuses, one or more retractable units on pulling unit 704 are operated to wind or unwind corresponding cables. For example, retractable unit 708-1, retractable unit 708-2, retractable unit 708-3, retractable unit 708-4, and retractable unit 708-5 are operated to unwind cable 706-1, cable 706-2, cable 706-3, cable 706-4, and cable 706-5 respectively to move apparatus 702-1 towards the object thereby positioning apparatus 702-1 on the object. Similarly, apparatus 702-2 and apparatus 702-3 are positioned on the object. Further, these apparatuses may be further positioned using one or more cables. For example, apparatus 702-1 is positioned using cable 708-6 and cable 708-7. The plurality of apparatuses is positioned such that one or more holding units of each apparatus are capable of drilling one or more holes in the object. In response to positioning apparatus 702-1, apparatus 702-2 and apparatus 702-3 on the object, each apparatus of these apparatuses hold the object by drilling the one or more holes in the object. This has already been explained in detail in conjunction with FIG. 6A and FIG. 6B.

In response to holding the object using apparatus 702-1, apparatus 702-2 and apparatus 702-3, pulling unit 704 pulls each of these apparatuses upwards in a synchronized manner. The pulling of each of these apparatuses results in pulling or lifting the object held by these apparatuses. In an embodiment, pulling unit 704 may be a magnetic pulling unit that may be capable of holding the plurality of apparatuses. In this case, the magnetic force and the force applied by the one or more retractable units and the cables may be used by pulling unit 704 for holding and pulling the plurality of apparatuses along with the object.

Various embodiments of the invention provide a system and an apparatus for holding an object. The system efficiently holds a fragmented object such as, a collapsed roof, at multiple points on the fragmented object thereby helping the system in carefully pulling the fragmented object. Moreover, the system prevents further fragmentation of the fragmented object by pulling the fragmented object at multiple points. Thus, the system may be used to pull and lift fragmented roofs and fragmented walls of a collapsed building. The pulling and lifting of the fragmented roofs and fragmented walls may be performed with minimum manual intervention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. An apparatus for holding an object, the apparatus comprising:
at least one holding unit, a holding unit of the at least one holding unit comprising a plurality of holding members, the holding unit operable between a contracted configuration and an expanded configuration to hold the object, wherein,
the holding unit in the contracted configuration is capable of drilling at least one hole in the object; and
the holding unit is capable of spreading the plurality of holding members within a hole of the at least one hole to achieve the expanded configuration and hold the object; and
a supporting unit coupled to the at least one holding unit, wherein the supporting unit comprises at least one motor to operate the at least one holding unit.

2. The apparatus of claim 1 further comprising at least one gripping unit operatively coupled to the supporting unit, wherein a gripping unit of the at least one gripping unit is capable of gripping the object thereby providing support for drilling the at least one hole in the object.

3. The apparatus of claim 2, wherein the gripping unit comprises at least one axe for gripping the object.

4. The apparatus of claim 1 further comprising at least one clamping unit, wherein a clamping unit of the at least one clamping unit operates the holding unit between the contracted configuration and the expanded configuration by clamping the plurality of holding members.

5. The apparatus of claim 1 further comprising at least one pulley mechanism operatively coupled to the supporting unit, wherein a pulley mechanism of the at least one pulley mechanism is capable of being operatively connected to a pulling unit for pulling the apparatus.

6. The apparatus of claim 5, wherein the pulley mechanism comprises at least one retractable unit, a retractable unit of the at least retractable unit is operatively connected with the pulling unit using at least one cable.

7. The apparatus of claim 5, wherein the pulley mechanism of the at least one pulley mechanism is operatively connected with the pulling unit for positioning the apparatus on the object.

8. The apparatus of claim 1, wherein the apparatus is capable of being held by a magnetic pulling unit.

9. The apparatus of claim 1, wherein the apparatus is capable of being held by a suction pulling unit.

10. The apparatus of claim 1 further comprising at least one wheel operatively coupled to the supporting unit.

11. A system for holding at least one object, the system comprising:
a plurality of apparatuses for holding the at least one object, each apparatus of the plurality of apparatuses comprising:
at least one holding unit configured to hold the at least one object, wherein a holding unit of the at least one holding unit comprises a plurality of holding members, the holding unit is operable between a contracted configuration and an expanded configuration to hold an object of the at least one object, wherein,
the holding unit in the contracted configuration is capable of drilling at least one hole in the object; and
the holding unit is capable of spreading the plurality of holding members within a hole of the at least one hole to achieve the expanded configuration and hold the object; and
a supporting unit coupled to the at least one holding unit, wherein
the supporting unit comprises at least one motor to operate the at least one holding unit; and
at least one pulling unit, a pulling unit of the at least one pulling unit is capable of pulling at least one apparatus of the plurality of apparatuses.

12. The system of claim 11, wherein each apparatus of the plurality of apparatuses further comprises at least one gripping unit operatively coupled to the supporting unit, wherein a gripping unit of the at least one gripping unit is capable of gripping the object thereby providing support for drilling the at least one hole in the object.

13. The system of claim 12, wherein the gripping unit comprises at least one axe for gripping the object.

14. The system of claim 11, wherein each apparatus of the plurality of apparatuses further comprises at least one pulley mechanism operatively coupled to a supporting unit of each apparatus, wherein the at least one pulley mechanism is capable of being operatively connected to the at least one pulling unit for pulling each apparatus.

15. The system of claim 14, wherein a pulley mechanism of the at least one pulley mechanism comprises at least one retractable unit, wherein a retractable unit of the at least one retractable unit operatively connected with the at least one pulling unit using at least one cable.

16. The system of claim 15, wherein the at least one retractable unit is used for positioning an apparatus of the plurality of apparatuses on the object.

17. The system of claim 11, wherein a pulling unit of the at least one pulling unit is a magnetic pulling unit.

18. The system of claim 11, wherein a pulling unit of the at least one pulling unit is a suction pulling unit.

19. The system of claim 11, wherein each apparatus of the plurality of apparatuses further comprises at least one wheel coupled to a supporting unit of each apparatus.

20. The system of claim 11, wherein each apparatus of the plurality of apparatuses further comprises a clamping unit operatively coupled to each holding unit of each apparatus, wherein a clamping unit operates a corresponding holding unit between the contracted configuration and the expanded configuration by clamping the plurality of holding members.
